(19) United States
(12) Patent Application Publication
(10) Pub. No.: US 2014/0299704 A1
(43) Pub. Date: Oct. 9, 2014

(54) RETRACTABLE CORD REEL

(71) Applicant: Edward J. Hollowed, Naperville, IL (US)

(72) Inventor: Edward J. Hollowed, Naperville, IL (US)

(21) Appl. No.: 14/245,691

(22) Filed: Apr. 4, 2014

Related U.S. Application Data
(60) Provisional application No. 61/809,026, filed on Apr. 5, 2013.

(51) Int. Cl. B65H 75/48; H02G 11/02

(52) U.S. Cl. CPC B65H 75/486; H02G 11/02
USPC 242/371

(57) ABSTRACT

A retractable electrical conductor cord reel assembly comprising a single continuous round cord from a display fixture cord end to a device cord end, wherein the cord includes a coiled portion disposed between a cord retention ring and the display fixture cord end to accommodate and/or compensate for torsional forces in the cord associated with the pay out and gathering of the cord.

### CROSS-REFERENCE TO RELATED APPLICATION

The present utility patent application claims priority from and the benefit of U.S. Provisional Patent Application No. 61/809,026, filed Apr. 5, 2013, entitled RETRACTABLE CORD REEL, the contents of which is hereby incorporated by reference in its entirety.

### FIELD OF THE DISCLOSURE

The present disclosure generally relates to a retractable cord reel for paying out (unwinding) and gathering in (winding) electrical power or other electrical power and/or signal conductor cords of portable electrical or electronic appliances, machine tools and other electrical/electronic devices where it is desirable to move the devices about during use. More particularly, the present disclosure relates to a retractable cord reel including a simple multiple plate assembly and a single continuous round cord without solder connections or changes in conductor physical layer that automatically pays out or takes up the slack in a conductor cord, as the position of the connected operating electrical or electronic device is varied. The technology of this disclosure may be particularly suited, in one embodiment, for the hands-on display and operative demonstration of electrical and electronic devices and the operative use thereof.

### BACKGROUND OF THE INVENTION

Retractable cord reels are commonly used in a wide variety of applications involving a wide range of environmental conditions, electrical signal types and numbers, and expected or required extension/retraction cycles. For example, retractable cord reels may be used in hazardous environments such as those that expose the cord reel to explosive gases, combustible fluids, etc., may be used in wet environments such as marine or other outdoor environments, may be used in environments that expose the cord reel to other contaminants such as dust, corrosive gases, oil, etc., to name a few. Additionally, some cord reels are used in applications involving a relatively large number of low power signals such as, for example, telephone applications, data transmission applications, etc. Many of these low power applications subject the cord reel to a relatively large number of extension/retraction cycles. Other cord reel applications involve a relatively small number of high power signals such as, for example, line voltage extension cord applications.

In any event, conventional retractable cord reel devices typically include a fixed portion of electrical cable and an extendable portion of cable. The extendable portion of electrical cable is usually wound on a spring-loaded spool and, thus, may be withdrawn or extended from the cord reel and, if desired, retracted back into the cord reel. As the extendable cable portion is withdrawn, it typically rotates the spool against the force of a spring. The energy stored in the spring may subsequently be used to rotate the spool in the opposite direction to retract the extendable cable portion into the cord reel. Of course, providing a continuous electrical connection between the fixed and extendable cable portions is not a simple matter, particularly due to the relative rotation between the fixed cable portion and the spool carrying the extendable cable portion.

Some known retractable cord reels utilize rotating contacts such as, for example, brushes and commutating rings, to provide electrical continuity between the fixed cable portion and the rotating spool on which the extendable cable portion is wound. With these types of cord reels, the extendable cable portion is usually electrically coupled to commutating rings that are integral to the rotating spool and the fixed cable portion is electrically coupled to brushes that are fixed to the cord reel housing and urged against the commutating rings. Unfortunately, such moving or rotating contacts are subject to wear and, thus, significantly reduce the life cycle of the cord reel. Further, these moving or rotating contacts have a propensity to generate sparks, which is unacceptable for use in hazardous environments and are prone to contamination from dirt, dust, liquids, etc. that may be common in many cord reel applications. Still further, rotating or moving contacts are electrically noisy, difficult to shield from environmentally induced noise and, as a result, are generally unsuitable for carrying low power, low-level signals.

More recently, some cord reels have been developed that eliminate the need for moving or rotating contacts. These cord reels utilize a substantially continuous cable having a flat portion and a round portion. The round portion of the cable is wound on a rotatable spool and the flat portion of the cable is spirally wound in an expansion chamber adjacent to a hub of the spool. As the round cable portion is withdrawn or extended from the cord reel, the spirally wound flat cable portion first unwinds or expands and then is rewound or contracts about a hub or other feature of the spool. Examples of such a cord reel is disclosed in U.S. Pat. Nos. 3,061,234 to Morey; 6,372,988 to Burke et al. and 7,108,216 to Burke et al. While cord reels having a substantially continuous electrical cable including a round extendable portion and a flat fixed portion have proved useful in a wide variety of applications including, for example, applications involving telephone signals, audio signals, data signals, etc., the cable used in such devices is typically relatively complicated and expensive to manufacture. Furthermore, while the types of cables used for many low power applications such as those noted above can be formed to have a relatively flat portion and a relatively round portion along a continuous length of cable, many cables such as, for example, heavy-gauge power cables are difficult, if not impossible, to modify in this manner. Still further, due to safety requirements, much heavy gauge flat cable utilizes a relatively thick and rigid jacket or insulation. As a result, a fixed portion made of such heavy gauge cable may fail prematurely, because when it transitions between the contraction and expansion modes within the expansion chamber bending stresses are typically concentrated at a single point or area of the cable over an approximately one hundred-eighty degree bending cycle.

Other types of retractable conductor cord reels heretofore been proposed with varying degrees of success.

Therefore, there is a need in the art for a retractable cord reel assembly, that has a simple construction and includes a single continuous round cord without solder connections or changes in conductor physical layer that automatically pays out or takes up the slack in a conductor cord, as the position of the connected operating electrical or electronic device is varied.

### BRIEF DESCRIPTION OF THE DRAWINGS

Certain embodiments are shown in the drawings. However, it is understood that the present disclosure is not limited to the arrangements and instrumentality shown in the attached drawings. The disclosure will be more readily understood in view of the following description when accompanied by the below figures and wherein like reference numerals represent like elements, wherein:

FIG. 1 illustrates an exploded front perspective view of one embodiment of a retractable cord reel of the present disclosure.

FIG. 2 illustrates an exploded rear perspective view of the retractable cord reel of FIG. 1.

FIG. 3 illustrates a detailed breakaway view of a front retention plate of the retractable cord reel of FIG. 1.

FIG. 4 illustrates a front perspective view of the retractable cord reel of FIG. 1.

### DETAILED DESCRIPTION OF THE PREFFERED EMBODIMENTS

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates. The following description of the embodiments is merely exemplary in nature and is in no way intended to limit the disclosure, its application, or uses.

In one aspect of the present disclosure, a retractable cord reel assembly may include a front retention plate, a cord retention ring, a middle retention plate and a rotational biasing assembly. A single continuous cord may include a display fixture cord distal end configured to engage a power/signal source, a coiled portion next to the display fixture distal end, a middle portion next to the coiled portion that extends into an inner volume and through an exit channel in the cord retention ring into an outer volume that is configured to be wound on and unwound from the cord retention ring, and a device cord distal end configured to engage an electronic device next to the middle portion. The coiled portion dynamically absorbs radial/torsional energy generated along the cord when the cord is wound on and unwound from the cord retention ring.

In other aspects of the present disclosure, the coiled portion has a maximum diameter when the middle portion of the cord is substantially wound around the cord retaining ring and a minimum diameter when the middle portion of the cord is substantially unwound from the cord retaining ring; and the cord includes a sheath and at least one continuous electrical conductor extending from the display fixture cord end to the device cord end disposed within the sheath that has an uninterrupted physical layer; the cord retention ring has a thickness that is greater than a thickness of the exit channel.

In another aspect of the present disclosure, a method of operating or using a retractable cord reel may include, moving a device end of a single continuous cord between a first operative orientation (substantially wound on the cord retaining ring) and a second operative orientation (substantially unwound from the cord retaining ring), and absorbing radial/torsional energy dynamically in the coiled portion in response to the moving step by decreasing the diameter of a coiled portion of the cord when the device end is moved from the first operative orientation to the second operative orientation and by increasing the diameter of the coiled portion when the device end is moved from the second operative orientation to the first operative orientation.

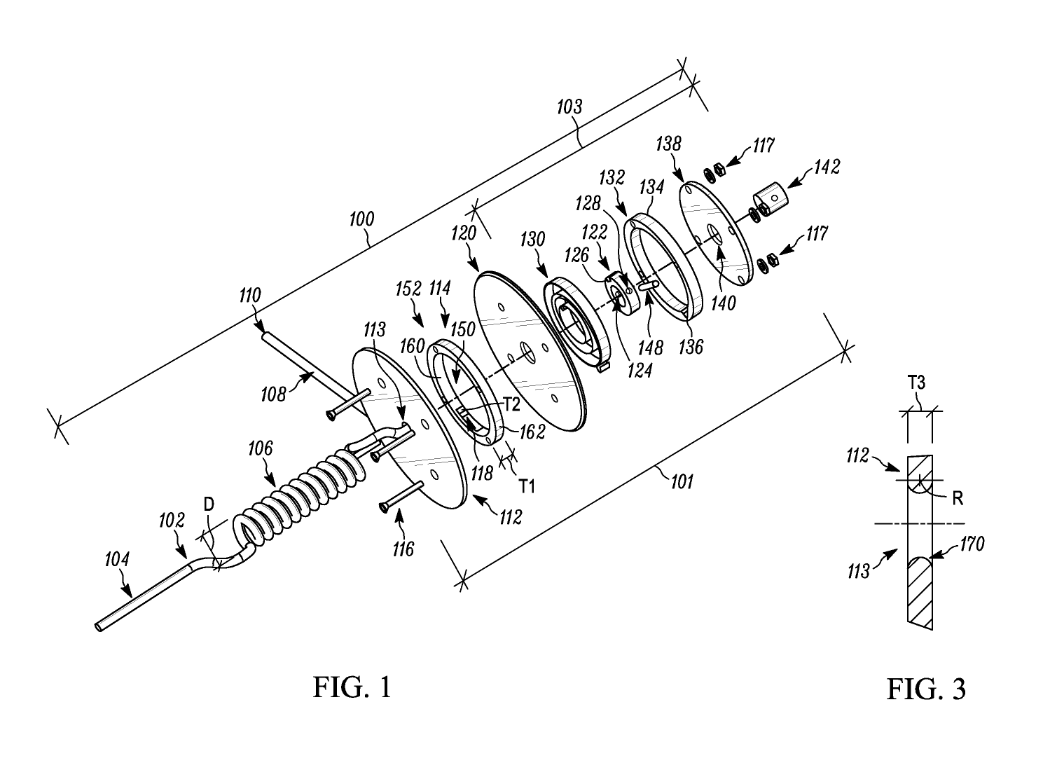

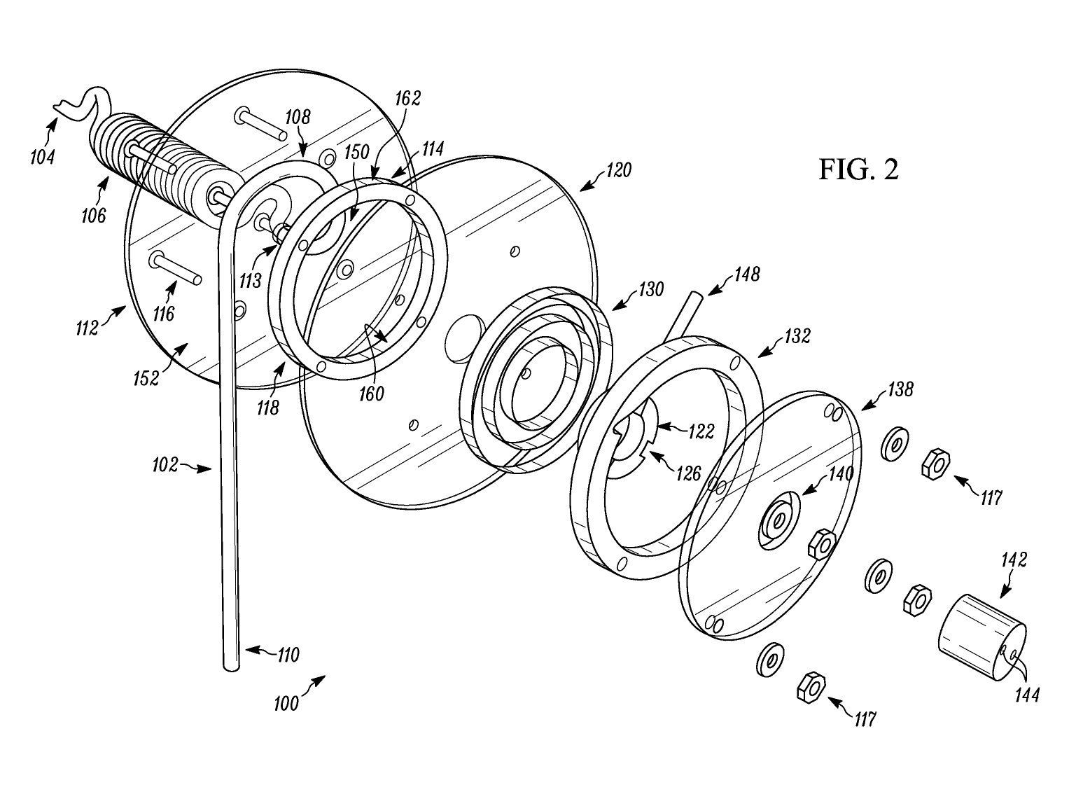

FIGS. 1 and 2 illustrate exploded front and rear perspective views of one embodiment of a retractable cord reel 100 of the present disclosure. The retractable cord reel 100 may include a single, continuous round cord 102 having a display fixture end 104, a coiled portion 106 disposed adjacent the display fixture end 104, a middle portion 108 and a device end 110. Preferably, the cord 102 has a round exterior profile and includes a sheath and at least one or a plurality of electrical conductors that have an uninterrupted physical layer to facilitate power, data, signal, etc. and the like. For example, the cord 102 may be useful in connection with a hands-on display and operative demonstration of electrical and electronic devices, such as mobile telephones, personal digital assistants, smart phones, tablets, power tools, etc. and the like, and the operative use thereof that a customer might find in a retail store that sells such products. In one such example, the retractable cord reel(s) 100 is/are installed inside a housing, display case, etc. or the like (not shown, but understood by one of ordinary skill in the art) substantially as shown herein such that the device cord end 110 is the only element that is observable by the customer, operator, etc. or the like. The continuous conductor path having an uninterrupted physical layer from input to output allows for conductors to be entirely shielded and used for EMI sensitive digital and analog signal or data transfer, in other words, realistic operation.

The display fixture distal end 104 may be connected to the power and/or signal source, such as, by hard wiring, an outlet, connector, receptacle, etc. or the like (not shown, but understood by one of skill in the art) and is preferably enclosed within a housing at the point of display in one embodiment. Preferably, the coiled portion 106 may be disposed between the display fixture end 104 and the middle portion 108 so as to accommodate, absorb and/or compensate for torsional or radial energy forces in the cord 102 associated with the pay out and gathering of the cord 102. In other words, the coiled portion 106 will tighten up (i.e., decrease a diameter D) during rotation in one direction (cord 102 being unwound, pulled or payed out) and loosened up (i.e., increase a diameter D, from the reduced or decreased diameter) when the cord 102 is wound, retracted or gathered. Accordingly, the coiled portion 106 of the cord 102 functions as a dynamic radial energy absorber for energy produced during the winding and unwinding of the cord 102 to the reel 100. The middle portion 108 extends continuously from the coiled portion 106 through an aperture 113 in a front retention plate 112 to which a cord retention ring 114 is connected (by four threaded fasteners 116 and cooperative fastener elements 117 in this embodiment, or any other suitable fastening or connection device or assembly that provides the desired functionality) so that the cord 102, and more specifically the middle 108, may be wound or wrapped around and disposed about and on the cord retention ring 114 after being passed through an exit channel 118.

The device end 110 is an opposite distal end of the cord 102 that preferably includes a connector (not shown, but understood by one of skill in the art) to facilitate connection of the cord 102 to the intended device, as described herein. The middle retention plate 120 cooperates with the front retention plate 112 and the cord retention ring 114 to define a channel for the cord 102.

In one embodiment, an inner housing 101 may be defined as including the front retention plate 112, the cord retention ring 114, the middle retention plate 120 and a rotational biasing assembly 103. The single continuous cord 102 may have a round exterior profile and include a display fixture cord distal end 104 configured to engage a power/signal source, the coiled portion 106 disposed adjacent the display fixture distal end 104 and external to the front retention plate 112, the middle portion 108 may be disposed adjacent the coiled portion 106 and extend through the aperture 113 in the front retention plate 112 into an inner volume 150 defined by an internal surface 160 of the cord retention ring 114 and the front and middle retention plates 112, 120 and through the exit channel 118 defined in the cord retention ring 114 into an outer volume 162 defined by an external surface 152 of the cord retention ring 114 and the front and middle retention plates 112, 120. The middle portion 108 may be configured to be wound on and unwound from the cord retention ring 114, and the device cord distal end 110 may be configured to engage the electronic device is disposed adjacent to the middle portion 108. The middle retention plate 120 may be connected to the front retention plate 112 and the cord retention ring 114 by the same fasteners 116, 117 whereby alignment of such parts is desirably achieved. Preferably, the front and middle retention plates 112, 120 may be made of any suitable material, such as, for example only, nylon 6-6, polyamide, etc. or the like.

Preferably, the coiled portion 106 has a maximum diameter D when the biasing assembly 103 is disposed in a first operative orientation defined when the middle portion 108 of the cord 102 is substantially wound around the cord retaining ring 114 in the outer volume 162 and a minimum diameter D when the biasing assembly 103 is disposed in a second operative orientation defined when the middle portion 108 of the cord 102 is substantially unwound from the cord retaining ring 114. In one preferable embodiment, the cord retention ring 114 may have a thickness T1 that is greater than a thickness T2 of the exit channel 118 and most preferably, only slightly thicker such that the cord 102 is controllably contained in the outer volume 162 but unwanted friction is not increased. Additionally, the cord retention ring 114 functions as a cord strain relief when the cord 102 is wound thereon. Preferably, the cord retention ring 114 may be made of any suitable material, such as, for example only, polyvinyl chloride, etc. or the like. In one embodiment, an alignment projection 180 may be provided that may be connected to the housing, adjacent the device fixture distal end, front retention plate 112, etc. or the like to facilitate alignment of the coiled portion 106 with the center of the reel 100 or aperture 113 of the front retention plate 112. The alignment projection 180 is preferably configured such that it does not interfere with the absorbing, accommodating, compensating, etc. or the like functionality.

As shown in FIG. 3, the aperture 113 in the front retention plate 112 has a rounded or contoured edge 170 defined by a radius R equal to one half a thickness T3 of the front retention plate 112 in order to facilitate not only smooth movement of the cord therethrough and in turning thereabout, but also to provide a desired friction level whereby torsional, radial, etc. or the like forces along the cord 102 may be absorbed, compensated or accommodated during operation of the reel 100 and to facilitate rotational or helical movement of the cord 102 that passes through the aperture 113 when the cord 102 pays out or is gathered in. Preferably, the front retention plate 112 may be made of any suitable material, such as, for example only, nylon 6-6, polyamide, etc. or the like.

The rotational biasing assembly 103 may be included in order to facilitate the pay out and gathering of the cord 102. An inner end of a power spring 130 is preferably connected to a power spring hub 122 that is connected by a retaining ring pin 148 to a bearing 142 that is fixedly secured to the housing in one embodiment, or any other suitable structure. An outer end of the power spring 130 is preferably connected to a power spring retention ring 132 that is secured to a rear retention plate 138 and the front and middle retention plates 112, 120 and cord retention ring 114 by common fasteners, so as to rotate relative to the fixed bearing 142 and power spring hub 122 assembly. The power spring hub 122 may include a longitudinal bore 124, peripherally formed notch 126 and a cross bore 128. Preferably, the longitudinal bore 124 is configured to receive a bearing, as will be described herein. For example, bearing 142 may be captured by power spring hub 122 by press fit of the retaining ring pin 148 or other suitable method, process, device, manner, etc. or the like. The notch 126 is preferably configured to receive one end of the power spring 130 that spring biases the retractable cord reel in a direction that winds the cord 108 and is preferably formed as a single, flat, spiral spring, or any other suitable biasing element as known by one of skill in the art having an inner end complementarily configured to be retained within the notch 126. The power spring 130 may be disposed about the power spring hub 122 in one embodiment. The cross bore 128 may be configured to facilitate connection of the power spring hub 122 to the bearing with a cross pin, as will be described herein. The cross bore 128 may extend across the longitudinal bore 124 in one embodiment or only extend through one wall of the power spring hub 122 in another embodiment. One of skill in the art will recognize that any suitable arrangement or configuration to connect the power spring hub 122 to the bearing will be suitable. Preferably, the power spring hub 122 may be made of any suitable material, such as, for example only, polyvinyl chloride, etc. or the like.

The power spring retention ring 132 may include a plurality of apertures 134 and a groove 136. Preferably, the apertures 134 align in registration with the apertures formed in the front and middle retention plates 112, 120, and cord retention ring 114 to accept the fasteners 116 to be cooperatively joined for simultaneous rotation. The groove 136 is preferably formed so as to include an end portion that is aligned in registration with one of the fasteners 116. However, the groove 136 is configured so as to receive an outer end of the power spring 130 (opposite to the inner end that engages the notch 126 of the power spring hub 122). The outer end of the power spring 130 is curled such that it may be complementarily received into the groove 136 and so that the fastener 116 when inserted through the aligned apertures will capture the outer end of the power spring 130 to secure it in position with respect to the power spring retention ring 132. Preferably, the power spring retention ring 132 may be made of any suitable material, such as, for example only, polyvinyl chloride, etc. or the like.

The rear retention plate 138 may be connected to the front and middle retention plates 112, 120 and the cord retention ring 114 by the same fasteners 116, 117 whereby alignment of such parts is desirably achieved. The rear retention plate 138 may include a center aperture 140 configured to accept the bearing therethrough, as will be described herein. Preferably, the rear retention plate 138 may be made of any suitable material, such as, for example only, nylon 6-6, polyamide, etc. or the like. The bearing 142 may include mounting bores 144 and a cross bore 146. The mounting bores 144 extend parallel along the longitudinal axis in one embodiment in order to facilitate secure connection of the bearing to a fixed point, such as the display fixture housing, by fasteners, as would be known to one of ordinary skill in the art, so as to provide the functionality as desired. Preferably, the retaining ring pin 148 may be made of any suitable material, such as, for example only, 300 series stainless steel, etc. or the like.

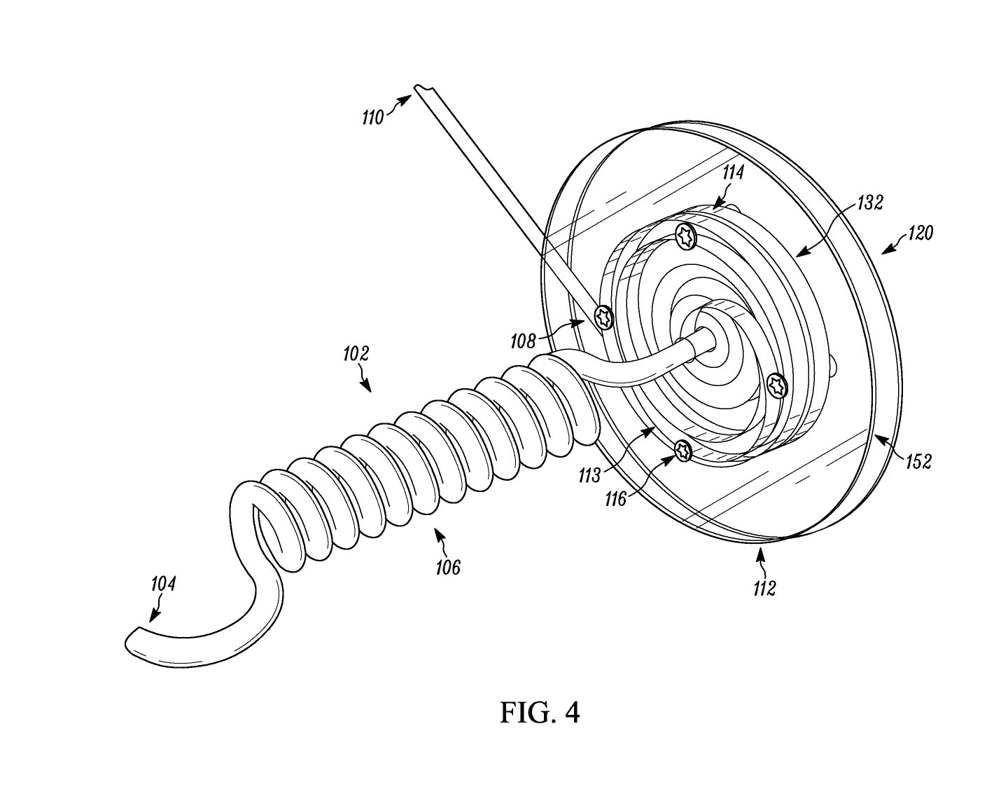

In the operation or use of the retractable reel assembly 100 as shown in FIG. 4, a customer that would like to examine a particular electrical or electronic device that is connected to the retractable reel assembly, in one embodiment, moves the device end 110 of the single continuous cord 102 having a round exterior profile between a first operative orientation defined when a middle portion 108 of the cord 102 is substantially wound around the cord retaining ring 114 in the outer volume 162 defined between the exterior surface 152 of the cord retaining ring 114 and the front retention plate 112 and the middle retention plate 120, and a second operative orientation defined when the middle portion 108 of the cord 102 is substantially unwound from the cord retaining ring 114; and radial, torsional, helical, etc. or the like energy is dynamically absorbed, accommodated, compensated, etc. or the like in the coiled portion 106 in response to the movement of the device distal end 110 by decreasing the diameter D of the coiled portion 106 of the cord 102 that is disposed between the display fixture end 110 disposed at a distal end of the cord 102 and the front retention plate 112 when the device end 110 is moved from the first operative orientation to the second operative orientation and by increasing the diameter D of the coiled portion 106 when the device end 110 is moved from the second operative orientation to the first operative orientation. Preferably, the coiled portion 106 has a maximum diameter D when the biasing assembly 103 is disposed in a first operative orientation defined when the middle portion 108 of the cord 102 is substantially wound around the cord retaining ring 114 in the outer volume 162 and a minimum diameter D when the biasing assembly 103 is disposed in a second operative orientation defined when the middle portion 108 of the cord 102 is substantially unwound from the cord retaining ring 114.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

1. A retractable cord reel assembly comprising:
an inner housing including a front retention plate, a cord retention ring, a middle retention plate and a rotational biasing assembly; and
a single continuous cord having a round exterior profile, said cord including a display fixture cord distal end configured to engage a power/signal source, a coiled portion disposed adjacent the display fixture distal end and external to the front retention plate, a middle portion disposed adjacent the coiled portion that extends through an aperture in the front retention plate into an inner volume defined by an internal surface of the cord retention ring and the front and middle retention plates and through an exit channel defined in the cord retention ring into an outer volume defined by an external surface of the cord retention ring and the front and middle retention plates, said middle portion configured to be wound on and unwound from the cord retention ring, and a device cord distal end configured to engage an electronic device disposed adjacent to the middle portion;
wherein the coiled portion dynamically absorbs radial energy generated along the cord when the cord is wound on and unwound from the cord retention ring.

2. The cord reel assembly of claim 1, wherein the coiled portion has a maximum diameter when the biasing assembly is disposed in a first operative orientation defined when the middle portion of the cord is substantially wound around the cord retaining ring in the outer volume and a minimum diameter when the biasing assembly is disposed in a second operative orientation defined when the middle portion of the cord is substantially unwound from the cord retaining ring.

3. The cord reel assembly of claim 1, wherein the cord includes a sheath and at least one continuous electrical conductor extending from the display fixture cord end to the device cord end disposed within the sheath that has an uninterrupted physical layer.

4. The cord reel assembly of claim 1, wherein the cord retention ring has a thickness that is greater than a thickness of the exit channel.

5. The cord reel assembly of claim 1, wherein the aperture in the front retention plate has an edge defined by a radius equal to one half a thickness of the front retention plate.

6. A method comprising:
moving a device end of a single continuous cord having a round exterior profile between a first operative orientation defined when a middle portion of the cord is substantially wound around a cord retaining ring in an outer volume defined between an exterior surface of the cord retaining ring and a front retention plate and a middle retention plate, and a second operative orientation defined when the middle portion of the cord is substantially unwound from the cord retaining ring; and
absorbing radial energy dynamically in the coiled portion in response to the moving step by decreasing the diameter of a coiled portion of the cord that is disposed between a display fixture end disposed at a distal end of the cord and the front retention plate when the device end is moved from the first operative orientation to the second operative orientation and by increasing the diameter of the coiled portion when the device end is moved from the second operative orientation to the first operative orientation.

7. The method of claim 6, wherein the cord includes a sheath and at least one continuous, uninterrupted electrical conductor extending from the display fixture cord end to the device cord end disposed within the sheath.

8. The method of claim 6, wherein the coiled portion has a maximum diameter when the biasing assembly is disposed in a first operative orientation defined when the middle portion of the cord is substantially wound around the cord retaining ring in the outer volume and a minimum diameter when the biasing assembly is disposed in a second operative orientation defined when the middle portion of the cord is substantially unwound from the cord retaining ring.
